(19) United States
(12) Patent Application Publication
(10) Pub. No.: US 2014/0085738 A1
(43) Pub. Date: Mar. 27, 2014

(54) Lensed Planar Reflective Surface for Automotive Auto Dimming Mirrors

(71) Applicants: Sihai Gary Qian, San Jose, CA (US); Gang Xu, Cupertino, CA (US)

(72) Inventors: Sihai Gary Qian, San Jose, CA (US); Gang Xu, Cupertino, CA (US)

(21) Appl. No.: 13/628,801

(22) Filed: Sep. 27, 2012

(51) Int. Cl. G02B 17/00

(52) U.S. Cl. 359/726

(57) ABSTRACT

A lensed planar reflective surface for automotive auto dimming mirror applications, including a lens and a planar variable attenuating reflective element in spaced relation so as to reflect light transmitted through the lens back through the lens; wherein the planar variable attenuating reflective element comprises: front and rear planar elements; a layer of transparent conductive material disposed on the rear surface of the front planar element; a reflective material disposed on one side of the rear planar element and a perimeter sealing member bonding together the front and rear planar elements in a spaced-apart relationship to define a planar chamber therebetween of uniform thickness, where the planar chamber contains at least one electrochromic material, and where the reflective material is effective to reflect light transmitted through the front planar element and the planar chamber back through the planar chamber and the front planar element. Other embodiments are described and claimed.

### I. BACKGROUND

The invention relates generally to the field of duplicating the narrower field of view and wider field of view resulting from convex or concave mirrors, respectively. More particularly, the invention relates to a device for either positively or negatively lensing a planar reflective surface. Additionally, the lensed planar reflective surface may also be attenuated.

### II. SUMMARY

In one respect, disclosed is a lensed, reflective element comprising: a lens and a planar reflective element in spaced relation to the lens so as to reflect light transmitted through the lens back through the lens. Wherein the lens is at least one of: a positive lens, a negative lens, a positive Fresnel lens, and a negative Fresnel lens. Wherein the planar reflective element comprises a planar substrate coated with a metallic material, wherein the metallic material is at least one of: silver, rhodium, aluminum, chrome, stainless steel, nickel, and alloys thereof. Wherein the lens may be coated with an anti-scratch coating, an anti-reflection coating, and/or an anti-fog coating.

In another respect, disclosed is a lensed, reflective element further comprising: a planar variable attenuating element in spaced relation between the lens and the planar reflective element so as to vary the attenuation of light transmitted through the lens and the variable attenuating element. Wherein the lens, the planar variable attenuating element, and the planar reflective element are mechanically coupled together or bonded together with an adhesive or bonded together with a laminating film. Wherein the adhesive comprises a cross-linked or thermoplastic polymer or a cross-linked or thermoplastic epoxy resin and wherein the laminating film is at least one of: a polyvinyl butyral film, a polyvinyl chloride film, and related polyurethane film. Wherein the planar variable attenuating element is at least one of: an electrochromic device, a liquid crystal device, an electro-wetting device, and a suspended particle device. Wherein the lens may be coated with an anti-scratch coating, an anti-reflection coating, and/or an anti-fog coating.

In another respect, disclosed is a lensed, reflective element further comprising: a planar variable attenuating element in spaced relation in front of the lens and the planar reflective element so as to vary the attenuation of light transmitted through the variable attenuating element and the lens.

In another respect, disclosed is a lensed, reflective element comprising: a lens and a planar variable attenuating reflective element in spaced relation to the lens so as to reflect light transmitted through the lens back through the lens; wherein the planar variable attenuating reflective element comprises: front and rear planar elements, each having front and rear surfaces; a layer of transparent conductive material disposed on the rear surface of the front planar element; a reflective material disposed on one side of the rear planar element provided that, if the reflective material is on the rear surface of the rear planar element, then the front surface of the rear planar element carries a layer of a transparent conductive material; and a perimeter sealing member bonding together the front and rear planar elements in a spaced-apart relationship to define a planar chamber therebetween of uniform thickness, where the planar chamber contains at least one electrochromic material, and where the reflective material is effective to reflect light transmitted through the front planar element and the planar chamber back through the planar chamber and the front planar element. Wherein the lens is at least one of: a positive lens, a negative lens, a positive Fresnel lens, and a negative Fresnel lens. Wherein the reflective material is at least one of: silver, rhodium, aluminum, chrome, stainless steel, nickel, and alloys thereof. Wherein the lens may be coated with an anti-scratch coating, an anti-reflection coating, and/or an anti-fog coating. Wherein the transparent conductive material is at least one of: indium-tin oxide, fluorine doped tin oxide, and fluorine doped zinc oxide. Wherein the perimeter sealing member comprises a cross-linked or thermoplastic polymer or a cross-linked or thermoplastic epoxy resin. Wherein the lens and the planar variable attenuating reflective element are mechanically coupled together or bonded together with an adhesive or bonded together with a laminating film. Wherein the adhesive comprises a cross-linked or thermoplastic polymer or a cross-linked or thermoplastic epoxy resin and wherein the laminating film is at least one of: a polyvinyl butyral film, a polyvinyl chloride film, and related polyurethane film. Wherein the planar variable attenuating reflective element is at least one of: an electrochromic device, a liquid crystal device, an electro-wetting device, and a suspended particle device.

In yet another respect, disclosed is a vehicle mirror assembly comprising: a lens and a planar reflective element in spaced relation to the lens so as to reflect light transmitted through the lens back through the lens. Wherein the planar reflective element comprises: front and rear planar elements, each having front and rear surfaces; a layer of transparent conductive material disposed on the rear surface of the front planar element; a reflective material disposed on one side of the rear planar element provided that, if the reflective material is on the rear surface of the rear planar element, then the front surface of the rear planar element carries a layer of a transparent conductive material; and a perimeter sealing member bonding together the front and rear planar elements in a spaced-apart relationship to define a planar chamber therebetween of uniform thickness, where the planar chamber contains at least one electrochromic material, and where the reflective material is effective to reflect light transmitted through the front planar element and the planar chamber back through the planar chamber and the front planar element. Wherein the lens may be coated with an anti-scratch coating, an anti-reflection coating, and/or an anti-fog coating.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a cross-sectional schematic representation of a negative lens coupled with a planar reflective surface, in accordance with some embodiments.

FIG. 2 is a cross-sectional schematic representation of a positive lens coupled with a planar reflective surface, in accordance with some embodiments.

FIG. 3 is a cross-sectional schematic representation of a negative Fresnel lens coupled with a planar reflective surface, in accordance with some embodiments.

FIG. 4 is a cross-sectional schematic representation of an attenuated, negative Fresnel lens coupled with a planar reflective surface, in accordance with some embodiments.

FIG. 5 is a cross-sectional schematic representation of an attenuated, negative Fresnel lens coupled with a planar reflective surface, in accordance with some embodiments.

FIG. 6 is a cross-sectional schematic representation of an attenuated, negative Fresnel lens coupled with a planar reflective surface, in accordance with some embodiments.

FIG. 7 is a cross-sectional schematic representation of a partially lensed, planar reflective surface, in accordance with some embodiments.

FIG. 8 is a cross-sectional schematic representation of a dual lensed, planar reflective surface, in accordance with some embodiments.

FIG. 9 is a cross-sectional schematic representation of a coated, lensed, planar reflective surface, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Curved reflective surfaces are used in many different applications, from automobile mirrors for enhancing the driver's field of view to large convex mirrors used in parking garages and driveways for assisting in viewing around obstructions. The cost of such curved mirrors is higher than if the reflective surfaces were planar due to the decreased mass production ability when working with curved substrates. Typically, curved reflective substrates have to be individually prepared and coated. Planar reflective substrates on the other hand may be cutout from a larger planar substrate sheet that is first coated with the reflective layer. The problem is compounded when dealing with non-planar variable attenuating mirrors such as auto dimming mirrors used in currently available vehicles. In a curved auto dimming mirror, the conducting plates of the attenuating cell have to be maintained at a constant gap, thus making it more difficult to fabricate, resulting in reduced yields and higher costs. These fabrication difficulties result in significantly lower mass productivity for curved substrates than for planar substrates. This invention provides a device having the benefits and advantages of curved reflective surfaces, but without the additional cost and fabrication disadvantages associated with curved reflective surfaces, and/or the curved attenuating cell.

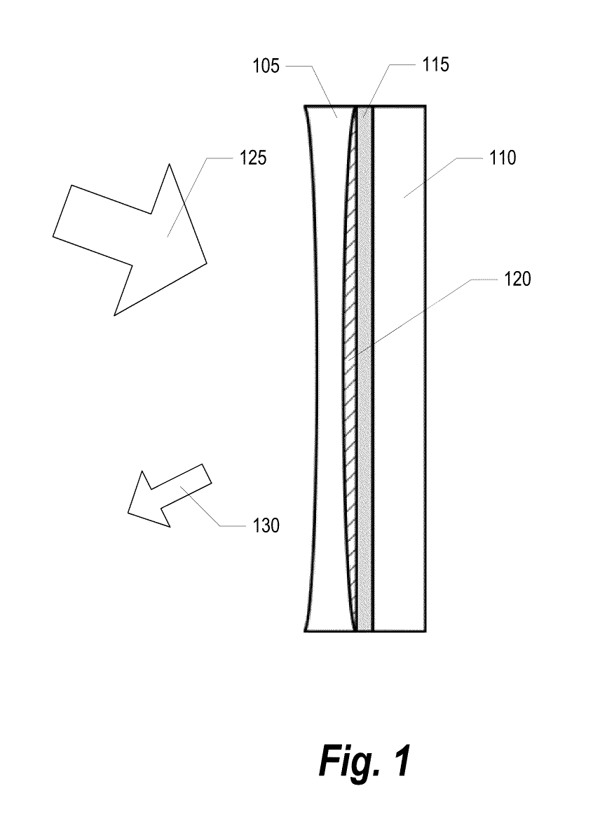

FIG. 1 is a cross-sectional schematic representation of a negative lens coupled with a planar reflective surface, in accordance with some embodiments.

In some embodiments, a negative (diverging) lens such as a concave lens 105 is coupled to a planar substrate 110 having a reflective layer 115 on the surface of the planar substrate 110 between the negative lens 105 and the planar substrate 110. The concave lens may be coupled with an optically transparent adhesive 120 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the concave lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 125 onto the concave lens 105 passes through the concave lens 105 and optically transparent adhesive 120 and subsequently reflected off the reflective layer 115. The reflected light then passes again through the optically transparent adhesive 120 and concave lens 105 before exiting. The reflected light 130 results in a reduced image size encompassing a wider field of view dependent on the effective focal length of the lens 105. The effective focal length is a function of the curvature of the lens 105, the optical index of the lens 105, and the optical index of the adhesive 120.

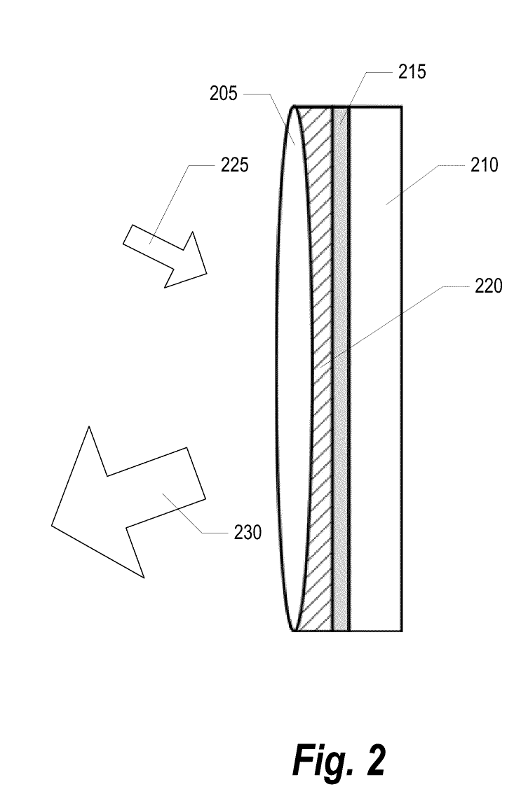

FIG. 2 is a cross-sectional schematic representation of a positive lens coupled with a planar reflective surface, in accordance with some embodiments.

In some embodiments, a positive (converging) lens such as a convex lens 205 is coupled to a planar substrate 210 having a reflective layer 215 on the surface of the planar substrate 210 between the positive lens 205 and the planar substrate 210. The convex lens may be coupled with an optically transparent adhesive 220 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the convex lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 225 onto the convex lens 205 passes through the convex lens 205 and optically transparent adhesive 220 and subsequently reflected off the reflective layer 215. The reflected light then passes again through the optically transparent adhesive 220 and convex lens 205 before exiting. The reflected light 230 results in an enlarged image size encompassing a narrower field of view dependent on the effective focal length of the lens 205. The effective focal length is a function of the curvature of the lens 205, the optical index of the lens 205, and the optical index of the adhesive 220.

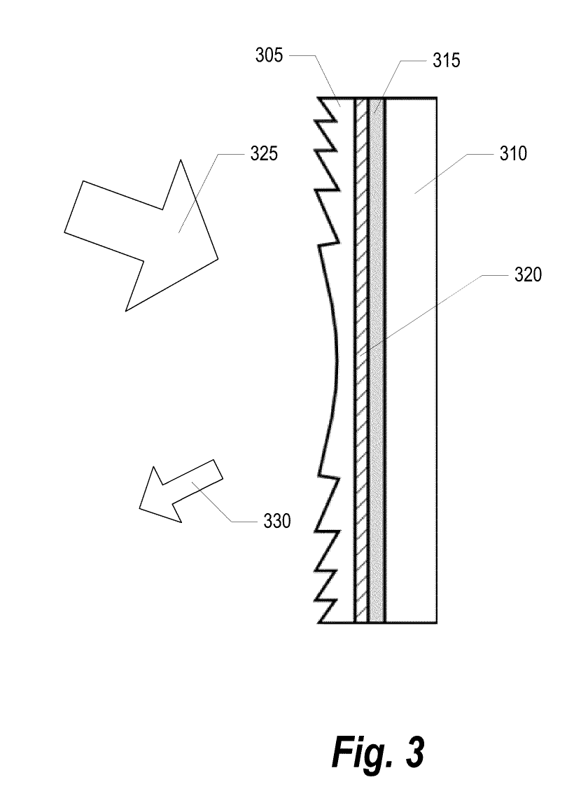

FIG. 3 is a cross-sectional schematic representation of a negative Fresnel lens coupled with a planar reflective surface, in accordance with some embodiments.

In some embodiments, a negative Fresnel lens 305 is coupled to a planar substrate 310 having a reflective layer 315 on the surface of the planar substrate 310 between the Fresnel lens 305 and the planar substrate 310. The Fresnel lens may be coupled with an optically transparent adhesive 320 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the Fresnel lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 325 onto the Fresnel lens 305 passes through the Fresnel lens 305 and optically transparent adhesive 320 and subsequently reflected off the reflective layer 315. The reflected light then passes again through the optically transparent adhesive 320 and Fresnel lens 305 before exiting. The reflected light 330 results in a reduced image size encompassing a wider field of view dependent on the effective focal length of the lens 305. The effective focal length is a function of the curvature and optical index of the lens 305. Alternatively, negative Fresnel lens 305 may be replaced by a positive Fresnel lens which would result in an enlarged image size encompassing a narrower field of view. In another alternative embodiment, the reflective layer 315 is deposited or coated directly onto the back side of the Fresnel lens 305. In such an embodiment, the optically transparent adhesive 320 and the planar substrate 310 are not required.

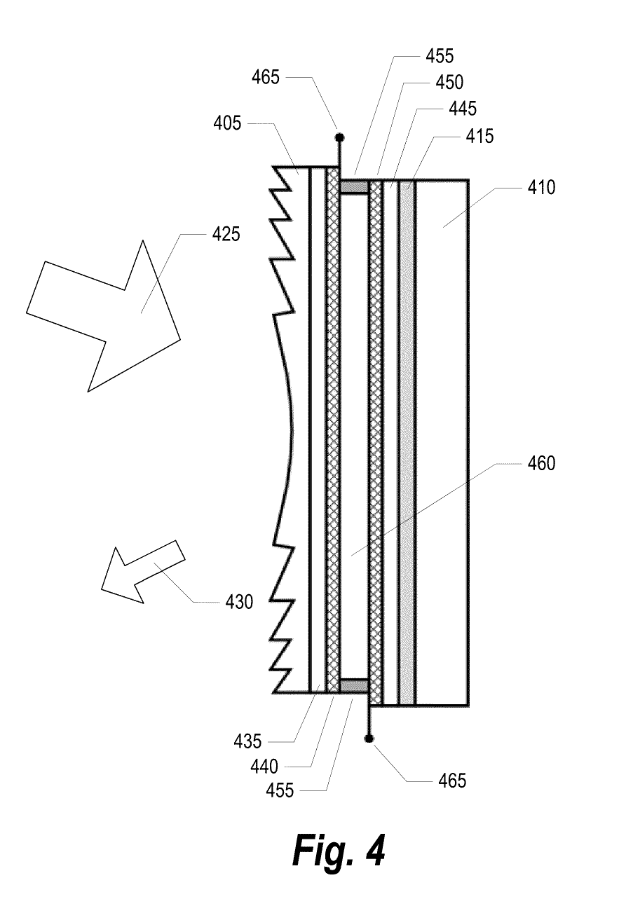

FIG. 4 is a cross-sectional schematic representation of an attenuated, negative Fresnel lens coupled with a planar reflective surface, in accordance with some embodiments.

In some embodiments, an electrochromic (EC) attenuator is sandwiched between a lens and a planar reflective surface. For clarity, the coupling mechanisms between the EC attenuator, the lens, and planar reflective surface are not shown in FIG. 4, but are similar to those shown and described in FIG. 1, FIG. 2, and FIG. 3. The EC attenuator comprises two substrates or elements, a front substrate 435 coated with a transparent conductive material 440 and a back substrate 445 coated with a transparent conductive material 450, joined by a perimeter sealing member 455 which encloses a chamber 460. The perimeter sealing member may comprise a cross-linked polymer, a thermoplastic polymer, a cross-linked epoxy resin, or a thermoplastic epoxy resin. The transparent conductive material 440 and 450 may comprise indium-tin oxide, fluorine doped tin oxide, fluorine doped zinc oxide, or any other similar optically transparent, electrically conductive material. For electrochromic mirror applications, the resistivity of the transparent conductors ranges from 1 to 100 Ohms. The chamber 460 is filled with an electrochromic electrolyte. The electrochromic electrolyte generally comprises at least one solvent, and a redox dye and possibly other ingredients such as redox dyes, polymers, soluble salts, and UV stabilizers. Power is applied between two terminals 465 which results in changes to the attenuation of the light passing through the EC attenuator. Other attenuating devices such as liquid crystal devices, electro-wetting devices, and suspended particle devices may be used in place of the EC attenuator. In the embodiment of FIG. 4, the EC attenuator is coupled between a negative Fresnel lens 405 and a planar substrate 410 having a reflective layer 415. Light incident 425 onto the Fresnel lens 405 passes through the Fresnel lens 405 and the EC attenuator and subsequently reflected off the reflective layer 415. The reflected light then passes again through the EC attenuator and Fresnel lens 405 before exiting. The reflected light 430 results in an attenuated, reduced image size encompassing a wider field of view dependent on the effective focal length of the lens 405. The effective focal length is a function of the curvature and optical index of the lens 405. Alternatively, negative Fresnel lens 405 may be replaced by a positive Fresnel lens which would result in an enlarged image size encompassing a narrower field of view. In yet other alternative embodiments, Fresnel lens 405 may be replaced by a conventional lens such as those disclosed in FIG. 1 and FIG. 2.

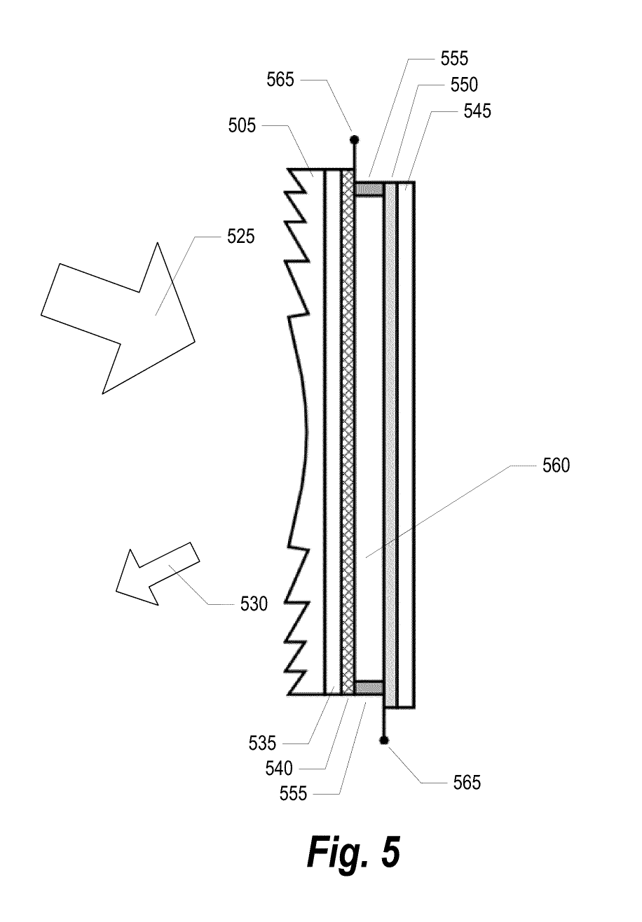

FIG. 5 is a cross-sectional schematic representation of an attenuated, negative Fresnel lens coupled with a planar reflective surface, in accordance with some embodiments.

In some embodiments, a reflector integrated into an electrochromic (EC) attenuator is coupled to a lens. For clarity, the coupling mechanisms between the EC attenuator and the lens is not shown in FIG. 5, but are similar to those shown and described in FIG. 1, FIG. 2, and FIG. 3. The EC attenuator comprises two substrates, a front substrate 535 coated with a transparent conductive material 540 and a back substrate 545 coated with a reflective conductive material 550, joined by a perimeter sealing member 555 which encloses a chamber 560. The layer 550 serves two functions, as both the reflective layer and the conductive layer. The perimeter sealing member may comprise a cross-linked polymer, a thermoplastic polymer, a cross-linked epoxy resin, or a thermoplastic epoxy resin. The transparent conductive material 540 may comprise indium-tin oxide, fluorine doped tin oxide, fluorine doped zinc oxide, or any other similar optically transparent, electrically conductive material. For electrochromic mirror applications, the resistivity of the transparent conductor ranges from 1 to 100 Ohms. The chamber 560 is filled with an electrochromic electrolyte. The electrochromic electrolyte generally comprises at least one solvent, and a redox dye and possibly other ingredients such as redox dyes, polymers, soluble salts and UV stabilizers. Power is applied between two terminals 565 which results in changes to the attenuation of the light passing through the EC attenuator. In the embodiment of FIG. 5, the EC attenuator with the integrated reflector is coupled to a negative Fresnel lens 505. Light incident 525 onto the Fresnel lens 505 passes through the Fresnel lens 505 and into the EC attenuator and subsequently reflected off the reflective conductor 550 of the EC attenuator. The reflected light then passes again through the EC attenuator and Fresnel lens 505 before exiting. The reflected light 530 results in an attenuated, reduced image size encompassing a wider field of view dependent on the effective focal length of the lens 505. The effective focal length is a function of the curvature and optical index of the lens 505. Alternatively, negative Fresnel lens 505 may be replaced by a positive Fresnel lens which would result in an enlarged image size encompassing a narrower field of view. In yet other alternative embodiments, Fresnel lens 505 may be replaced by a conventional lens such as those disclosed in FIG. 1 and FIG. 2.

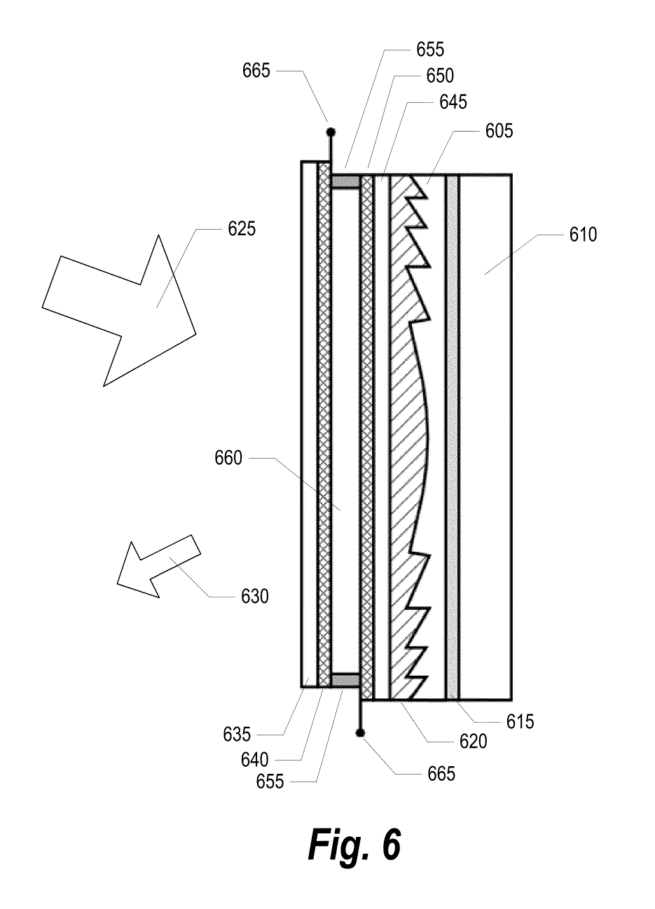

FIG. 6 is a cross-sectional schematic representation of an attenuated, negative Fresnel lens coupled with a planar reflective surface, in accordance with some embodiments.

In some embodiments, a lens is sandwiched between an electrochromic (EC) attenuator and a planar reflective surface. For clarity, the coupling mechanisms between the lens and planar reflective surface is not shown in FIG. 6, but is similar to those shown and described in FIG. 1, FIG. 2, and FIG. 3. The EC attenuator comprises two substrates, a front substrate 635 coated with a transparent conductive material 640 and a back substrate 645 coated with a transparent conductive material 650, joined by a perimeter sealing member 655 which encloses a chamber 660. The perimeter sealing member may comprise a cross-linked polymer, a thermoplastic polymer, a cross-linked epoxy resin, or a thermoplastic epoxy resin. The transparent conductive material 640 and 650 may comprise indium-tin oxide, fluorine doped tin oxide, fluorine doped zinc oxide, or any other similar optically transparent, electrically conductive material. For electrochromic mirror applications, the resistivity of the transparent conductors ranges from 1 to 100 Ohms. The chamber 660 is filled with an electrochromic electrolyte. The electrochromic electrolyte generally comprises at least one solvent, and a redox dye and possibly other ingredients such as redox dyes, polymers, soluble salts and UV stabilizers. Power is applied between two terminals 665 which results in changes to the attenuation of the light passing through the EC attenuator. Other attenuating devices such as liquid crystal devices, electro-wetting devices, and suspended particle devices may be used in place of the EC attenuator. In the embodiment of FIG. 6, a negative Fresnel lens 605 is coupled between the EC attenuator and a planar substrate 610 having a reflective layer 615. Light incident 625 onto the EC attenuator passes through the EC attenuator, an optically transparent adhesive 620 or some other laminating film, and the Fresnel lens 605 and subsequently reflected off the reflective layer 615. The reflected light then passes again through the Fresnel lens 605, the optically transparent adhesive 620, and EC attenuator before exiting. The reflected light 630 results in an attenuated, reduced image size encompassing a wider field of view dependent on the effective focal length of the lens 605. The effective focal length is a function of the curvature of the lens 605, the optical index of the lens 605, and the optical index of the adhesive 620. Alternatively, negative Fresnel lens 605 may be replaced by a positive Fresnel lens which would result in an enlarged image size encompassing a narrower field of view. In another alternative embodiment, the reflective layer 615 is deposited or coated directly onto the back side of the Fresnel lens 605. In such an embodiment, the optically transparent adhesive and the planar substrate 610 are not required. In yet other alternative embodiments, Fresnel lens 605 may be replaced by a conventional lens such as those disclosed in FIG. 1 and FIG. 2.

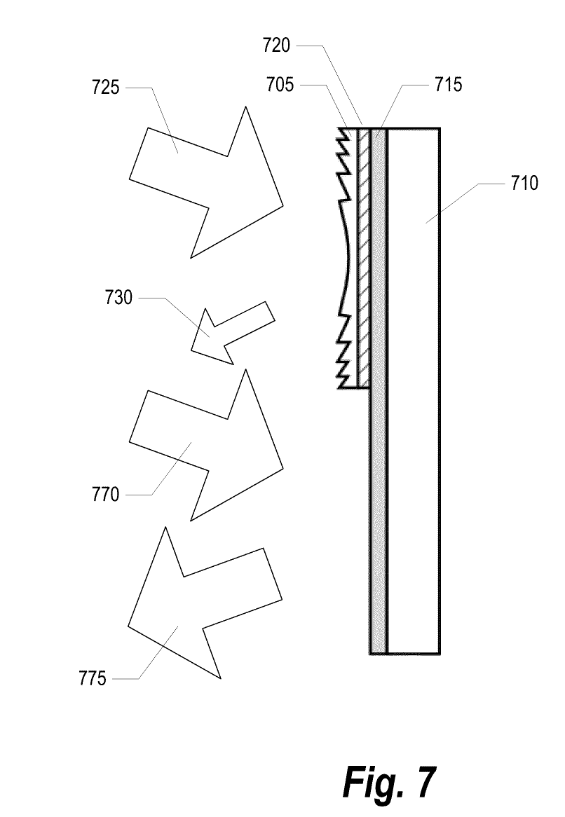

FIG. 7 is a cross-sectional schematic representation of a partially lensed, planar reflective surface, in accordance with some embodiments.

In some embodiments, a negative Fresnel lens 705 is coupled to a portion of planar substrate 710 having a reflective layer 715 on the surface of the planar substrate 710 between the Fresnel lens 705 and the planar substrate 710. The Fresnel lens may be coupled with an optically transparent adhesive 720 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the Fresnel lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 725 onto the Fresnel lens 705 passes through the Fresnel lens 705 and optically transparent adhesive 720 and subsequently reflected off the reflective layer 715. The reflected light then passes again through the optically transparent adhesive 720 and Fresnel lens 705 before exiting. The reflected light 730 results in a reduced image size encompassing a wider field of view dependent on the effective focal length of the lens 705. The effective focal length is a function of the curvature and optical index of the lens 705. Light incident 770 onto the reflective layer 715 is reflected back 775 without any resulting reduction or enlargement of the image size. Alternatively, negative Fresnel lens 705 may be replaced by a positive Fresnel lens which would result in an enlarged image size encompassing a narrower field of view. In yet other alternative embodiments, Fresnel lens 705 may be replaced by a conventional lens such as those disclosed in FIG. 1 and FIG. 2.

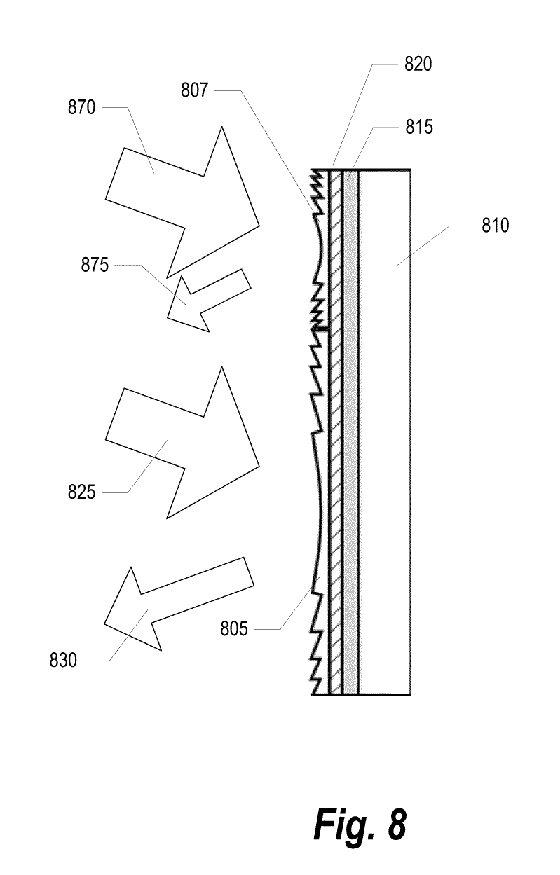

FIG. 8 is a cross-sectional schematic representation of a dual lensed, planar reflective surface, in accordance with some embodiments.

In some embodiments, two negative Fresnel lenses 805 and 807 are coupled to a planar substrate 810 having a reflective layer 815 on the surface of the planar substrate 810 between the Fresnel lenses 805 and 807 and the planar substrate 810. The Fresnel lens 805 has a longer focal length than the Fresnel lens 807. Since the Fresnel lens 807 has a shorter focal length, it is achieves a wider field of view than the Fresnel lens 805. The Fresnel lenses may be coupled with an optically transparent adhesive 820 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the Fresnel lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 825 onto the Fresnel lens 805 passes through the Fresnel lens 805 and optically transparent adhesive 820 and subsequently reflected off the reflective layer 815. The reflected light then passes again through the optically transparent adhesive 820 and Fresnel lens 805 before exiting. The reflected light 830 results in a reduced image size encompassing a wider field of view dependent on the effective focal length of the lens 805. The effective focal length is a function of the curvature and optical index of the lens 805. Light incident 870 onto the Fresnel lens 807 passes through the Fresnel lens 807 and optically transparent adhesive 820 and subsequently reflected off the reflective layer 815. The reflected light then passes again through the optically transparent adhesive 820 and Fresnel lens 807 before exiting. The reflected light 875 results in a further reduced image size encompassing an even wider field of view as compared to 830. The size of the further reduced image is a function of the curvature and optical index of the lens 807. Alternatively, negative Fresnel lens 805 and/or 807 may be replaced by positive Fresnel lenses which would result in an enlarged image size encompassing a narrower field of view. In another alternative embodiment, the reflective layer 815 is deposited or coated directly onto the back side of the Fresnel lenses 805 and 807. In such an embodiment, the optically transparent adhesive 820 and the planar substrate 810 are not required. In yet other alternative embodiments, Fresnel lens 805 and/or 807 may be replaced by a conventional lens such as those disclosed in FIG. 1 and FIG. 2.

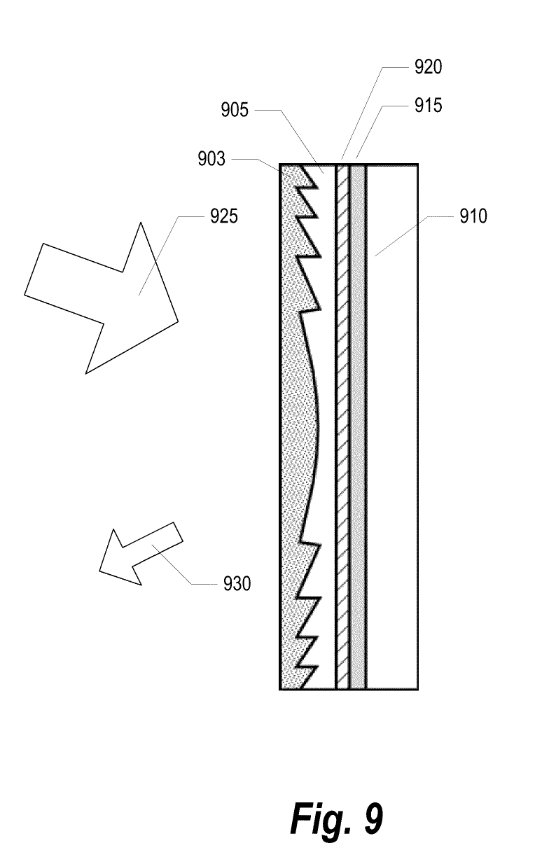

FIG. 9 is a cross-sectional schematic representation of a coated, lensed, planar reflective surface, in accordance with some embodiments.

In some embodiments, a negative Fresnel lens 905 is coated with a coating 903. The coating 903 may comprise an anti-scratch coating, an anti-reflection coating, an anti-fog coating, or combinations thereof. The Fresnel lens 905 is coupled to a planar substrate 910 having a reflective layer 915 on the surface of the planar substrate 910 between the Fresnel lens 905 and the planar substrate 910. The Fresnel lens may be coupled with an optically transparent adhesive 920 or some other laminating film such as polyvinyl butyral (PVB), polyvinyl chloride, or a polyurethane comprising material. The adhesive may also just be used around the perimeter of the reflective surface. The adhesives for the perimeter are preferably cross-linked or thermoplastic polymers and epoxy resins. Alternatively, instead of using adhesives or laminating films, the Fresnel lens may be mechanically coupled to the reflective planar substrate with a clamp or retaining ring. The reflective layer may be a metallic foil or plate, multi-layer reflective coating, or a metallic coating made from some preferred metal such as silver, rhodium, aluminum, chrome, stainless steel, nickel, and their alloys. Light incident 925 onto the Fresnel lens 905 passes through the coating 903, the Fresnel lens 905, and optically transparent adhesive 920 and subsequently reflected off the reflective layer 915. The reflected light then passes again through the optically transparent adhesive 920, Fresnel lens 905, and the coating 903 before exiting. The reflected light 930 results in a reduced image size encompassing a wider field of view dependent on the effective focal length of the lens 905. The effective focal length is a function of the curvature of the lens 905, the optical index of the lens 905, and the optical index of the coating 903. Alternatively, negative Fresnel lens 905 may be replaced by a positive Fresnel lens which would result in an enlarged image size encompassing a narrower field of view. In another alternative embodiment, the reflective layer 915 is deposited or coated directly onto the back side of the Fresnel lenses 905. In such an embodiment, the optically transparent adhesive 920 and the planar substrate 910 are not required. In yet other alternative embodiments, Fresnel lens 905 may be replaced by a conventional lens such as those disclosed in FIG. 1 and FIG. 2.

In some embodiments, the lensed, reflective element described and shown in FIGS. 1-9 may be integrated into a vehicle mirror assembly. The vehicle mirror assembly may be used as an interior rear view mirror or an exterior side view mirror, either driver side or passenger side. The cost of the vehicle mirror assembly should be comparable to conventional variable attenuation mirrors which are not lensed.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A lensed, reflective element comprising:
a lens and a planar reflective element in spaced relation to the lens so as to reflect light transmitted through the lens back through the lens.

2. The lensed, reflective element of claim 1, wherein the lens is at least one of: a positive lens, a negative lens, a positive Fresnel lens, and a negative Fresnel lens.

3. The lensed, reflective element of claim 1, wherein the planar reflective element comprises a planar substrate coated with a metallic material, wherein the metallic material is at least one of: silver, rhodium, aluminum, chrome, stainless steel, nickel, and alloys thereof.

4. The lensed, reflective element of claim 1, wherein the lens is coated with an anti-scratch coating, an anti-reflection coating, and/or an anti-fog coating.

5. The lensed, reflective element of claim 1, further comprising a planar variable attenuating element in spaced relation between the lens and the planar reflective element so as to vary the attenuation of light transmitted through the lens and the variable attenuating element.

6. The lensed, reflective element of claim 5, wherein the lens, the planar variable attenuating element, and the planar reflective element are mechanically coupled together or bonded together with an adhesive.

7. The lensed, reflective element of claim 6, wherein the adhesive comprises a cross-linked or thermoplastic polymer or a cross-linked or thermoplastic epoxy resin.

8. The lensed, reflective element of claim 5, wherein the lens, the planar variable attenuating element, and the planar reflective element are bonded together with a laminating film.

9. The lensed, reflective element of claim 8, wherein the laminating film is at least one of: a polyvinyl butyral film, a polyvinyl chloride film, and related polyurethane film.

10. The lensed, reflective element of claim 5, wherein the planar variable attenuating element is at least one of: an electrochromic device, a liquid crystal device, an electro-wetting device, and a suspended particle device.

11. The lensed, reflective element of claim 1, further comprising a planar variable attenuating element in spaced relation in front of the lens and the planar reflective element so as to vary the attenuation of light transmitted through the variable attenuating element and the lens.

12. A lensed, reflective element comprising:
a lens and a planar variable attenuating reflective element in spaced relation to the lens so as to reflect light transmitted through the lens back through the lens;
wherein the planar variable attenuating reflective element comprises:
front and rear planar elements, each having front and rear surfaces;
a layer of transparent conductive material disposed on the rear surface of the front planar element;
a reflective material disposed on one side of the rear planar element provided that, if the reflective material is on the rear surface of the rear planar element, then the front surface of the rear planar element carries a layer of a transparent conductive material; and a perimeter sealing member bonding together the front and rear planar elements in a spaced-apart relationship to define a planar chamber therebetween of uniform thickness, where the planar chamber contains at least one electrochromic material, and where the reflective material is effective to reflect light transmitted through the front planar element and the planar chamber back through the planar chamber and the front planar element.

13. The lensed, reflective element of claim 12, wherein the lens is at least one of: a positive lens, a negative lens, a positive Fresnel lens, and a negative Fresnel lens.

14. The lensed, reflective element of claim 12, wherein the reflective material is at least one of: silver, rhodium, aluminum, chrome, stainless steel, nickel, and alloys thereof.

15. The lensed, reflective element of claim 12, wherein the lens is coated with an anti-scratch coating, an anti-reflection coating, and/or an anti-fog coating.

16. The lensed, reflective element of claim 12, wherein the transparent conductive material is at least one of: indium-tin oxide, fluorine doped tin oxide, and fluorine doped zinc oxide.

17. The lensed, reflective element of claim 12, wherein the perimeter sealing member comprises a cross-linked or thermoplastic polymer or a cross-linked or thermoplastic epoxy resin.

18. The lensed, reflective element of claim 12, wherein the lens and the planar variable attenuating reflective element are mechanically coupled together or bonded together with an adhesive.

19. The lensed, reflective element of claim 18, wherein the adhesive comprises a cross-linked or thermoplastic polymer or a cross-linked or thermoplastic epoxy resin.

20. The lensed, reflective element of claim 12, wherein the lens and the planar variable attenuating reflecting element are bonded together with a laminating film.

21. The lensed, reflective element of claim 20, wherein the laminating film is at least one of: a polyvinyl butyral film, a polyvinyl chloride film, and related polyurethane film.

22. The lensed, reflective element of claim 12, where the planar variable attenuating reflective element is at least one of: an electrochromic device, a liquid crystal device, an electro-wetting device, and a suspended particle device.

23. A vehicle mirror assembly comprising:
a lens and a planar reflective element in spaced relation to the lens so as to reflect light transmitted through the lens back through the lens.

24. The vehicle mirror assembly of claim 23, wherein the planar reflective element comprises:
front and rear planar elements, each having front and rear surfaces;
a layer of transparent conductive material disposed on the rear surface of the front planar element;
a reflective material disposed on one side of the rear planar element provided that, if the reflective material is on the rear surface of the rear planar element, then the front surface of the rear planar element carries a layer of a transparent conductive material; and a perimeter sealing member bonding together the front and rear planar elements in a spaced-apart relationship to define a planar chamber therebetween of uniform thickness, where the planar chamber contains at least one electrochromic material, and where the reflective material is effective to reflect light transmitted through the front planar element and the planar chamber back through the planar chamber and the front planar element.
